(19) United States
(12) Patent Application Publication
(10) Pub. No.: US 2008/0047182 A1
(43) Pub. Date: Feb. 28, 2008

(54) Apparatus and Method for Attaching Signs to Vehicular Surfaces

(75) Inventors: Antonio F. Uccello III, Bradenton, FL (US); Andrei A. Troubeev, Sarasota, FL (US)

Correspondence Address: FISH & RICHARDSON P.C., P.O. BOX 1022, MINNEAPOLIS, MN, 55440-1022, US

(73) Assignee: Sign Media Systems, Inc., Sarasota, FL (US)

(21) Appl. No.: 11/573,809

(22) PCT Filed: Aug. 16, 2005
(86) PCT No.: PCT/US05/31969

§ 371 Date: Nov. 16, 2007

Related U.S. Application Data
(60) Provisional application No. 60/602,294, filed on Aug. 17, 2004.

(51) Int. Cl. G09F 21/04; A47G 1/06; A47G 1/17

(52) U.S. Cl. 40/591

(57) ABSTRACT

A framing system for mounting flexible or bendable signs to side panels (20) of cargo vans without piercing the panels includes framing members (2) with open U-shaped channels (10) adhesively applied to panels and cover members (6) pressingly engageable in said channels to hold signs (30) within a frame defined by the framing members.

### TECHNICAL FIELD

This invention relates to signage, and more particularly to mounting signs to the outside surfaces, including non-planar surfaces, of vehicular surfaces without penetration thereof.

### BACKGROUND

Apparatus and methods for attaching signs to panel sides of truck cargo bodies and trailers are known. See, for example, published international patent application WO 03/60333A2, which discloses apparatus that includes framing members consisting of shaped aluminum extrusions or “rails” into which beaded edges of large flexible vinyl signs may be inserted and tensioned utilizing additional shaped aluminum rails as anchors. Fixed framing rails and tensioning rails are affixed to a panel side by riveting or bolting. Application of such a system to certain vehicular surfaces is impractical or undesirable for three reasons. First, the surfaces, for example the sides and certain rear panels of cargo vans, are not flat. Riveting shaped aluminum extrusions either might not be possible or might distort the panels of the van, which tend to be made of lightweight metal or even plastic. Second, it is considered undesirable to penetrate side and rear panels of cargo vans as that can lead to water leakage and, in the case of steel panels to rusting. Third, holes in the panels reduce the resale value of a cargo van, because many potential buyers would not want to mount signs on the side or rear panels.

### SUMMARY

This invention includes a frame for signs that is mountable on side and rear panels of a cargo van. A cargo van is a motor vehicle, considered a truck in the U.S.A., that has a unitary cab and cargo body rather than separate cab and cargo bodies on either one or multiple vehicular frames.

Frames of this invention include components of two types. The first type, which we refer to as “framing members” are linearly extending extrusions that can be cut to length, mitered for comers as appropriate, and chemically adhered to a panel surface, as by glue or tape, so as to conform to the surface of the panel, whether flat or curved. The framing members include a planar bottom to be applied to the panel and perpendicularly extending sides or projections forming an open, outwardly facing, generally U-shaped channel extending axially lengthwise along the framing members. Preferably the bottom of the framing member is wider than the channel, forming an axially extending “wing” that adds stability when the member is mounted and that can be utilized to adhere the member to the panel.

Framing members generally plastic extrusions, for example, vinyl plastic such as polyvinyl chloride (PVC) extrusions. Their channel-forming elements have sufficient rigidity to be shape-retaining so as to contain locking covers, described below, but the framing members have sufficient flexibility to be conformable by hand and securable to the curvature likely to be encountered in cargo van panels.

Frames of this invention also include flexible, resiliently deformable covers engageable with the framing members to secure a sign to the frame. The covers are also linearly extending extrusions. They are generally synthetic plastic material, but they may be rubber or synthetic elastomeric composition. They should resist stretching. They include a resiliently compressible elongated protrusion that is lockingly engageable with the channels described above so as to lock the covers to the framing members during use. Covers are removable from channels and preferably reusable when signs are changed. Compressibility can be enhanced as required by construction of the locking protrusion as well as its composition, for example by utilizing cross-sectional shapes that permit bending deformation. Covers may comprise individually cut strips for individual frame members or a single strip for a frame, that is, for all framing members of a frame.

Frames according to this invention are useful to mount non-rigid signs. One type of non-rigid sign is a relatively stiff sheet that can be bent or deformed by hand to conform to the panel to which it is being applied. For example, signs may be corrugated cardboard (coated for waterproofing) or similar construction of synthetic polymeric material, typically about one-fourth inch (0.6 cm) in thickness. Such a sign is sized or cut to fit in the space defined by the framing member channels. In this embodiment the cover extends perpendicularly from the channels (outwardly from the channel bottoms) and inwardly with respect to the sign so as to cover its edges. The cover is shaped so as to press the sign edges against the panel, or the framing member wing overlying the panel, so as to hold the sign in place firmly. Preferably the cover also has an opposed extension so as to press against the panel area outside the channel. In cross section the cover may be angular, somewhat like an arrowhead or flattened arrowhead, but we prefer that it have a slightly rounded shape, somewhat like a mushroom. The cover strips preferably are mitered or notch cut so that they appear to provide a continuous frame sealed tightly on the outside against the panel and on the inside against the sign. This imparts an attractive appearance and prevents wind from flowing under the cover, which might lift its edges.

Another type of non-rigid sign is a flexible sheet, typically a vinyl sheet. Such a sign is sized or cut to be sufficiently large to be pressed into the frame-member channels, thereby covering the inside surfaces of the channel elements, at least the inner sides of the channels, preferably also the bottoms of the channels, and more preferably also the outer sides of the channels. A cover protrusion is pressed into a channel with the sign edge already in place in or at least over the channels so as to lock in the sign into the channels. A simple tool such as a flat wooden or plastic stick may be used to press a sign edge into a channel. A vinyl sheet so deformed will stay in a channel until a locking cover can be applied. In this embodiment the cover element or “wing” extending inwardly toward the middle of the sign presses down on the sign and helps to tension the sign. It is preferably, but not necessary that the sign be pressed against the panel (or overlying frame-member wing) on which it is mounted.

Covers for this embodiment are generally of a similar cross section as described for the first embodiment. As will be appreciated, however, the protrusion engageable with channel must be insertable with at least one and preferably two thicknesses of flexible sheet inside the channel. Depending on channel width, sign thickness and protrusion design, a cover for the second embodiment may function also as a cover for the first embodiment. If necessary, two covers may be utilized for the two embodiments.

Chemical bonding of frame members to a panel can be accomplished with a variety of materials utilizing a variety of procedures. The requirement is that bonding be achieved quickly, either on contact or at least in under one minute, when a frame member is pressed against the panel. Our most preferred material is high-strength double-sided adhesive tape, for example VHB™ high bonding strength double-sided tape available from 3M Company (St. Paul, Minn., U.S.A.). Our preferred method is to apply double-sided tape to the underside of frame member lengths from which individual frame members are to be cut, leaving removable parting film on the exposed side of the tape for removal at the point of installation on a panel. Alternatively single-sided high bonding strength tape could be affixed to the underside of frame members, as by gluing; or contact cement could be applied both to the panel and to the frame member undersides; or a quick-setting high bonding strength adhesive could be applied either to the panel or to the frame member undersides, or both, during installation. All of these materials and methods can be used for mounting frames without placing holes in the panels.

The details of one or more embodiments of the invention are set forth in the accompanying drawings and the description below. Other features, objects, and advantages of the invention will be apparent from the description and drawings, and from the claims.

### DESCRIPTION OF DRAWINGS

FIG. 1 is a perspective view of a partially constructed frame according to this invention.

FIG. 2 is a cross-sectional view of a side of a frame according to a first embodiment of this invention containing a stiff sign board.

FIG. 3 is a cross-sectional view of a side of a frame according to a second embodiment of this invention containing a flexible sign.

Like reference symbols in the various drawings indicate like elements.

### DETAILED DESCRIPTION

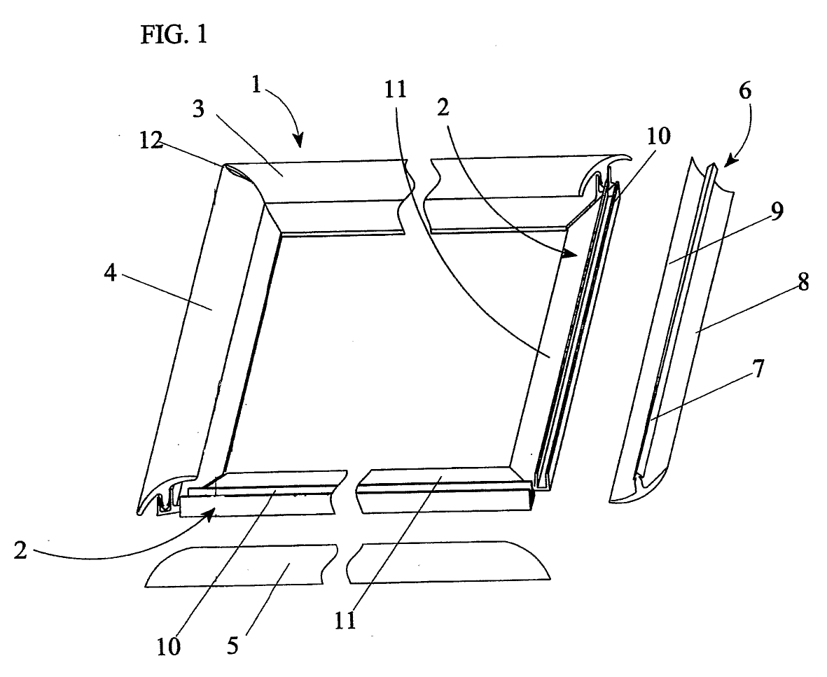

FIGS. 1-3 depict certain embodiments of apparatus according to this invention. FIG. 1 shows a partially assembled frame 1, a rectangular frame that includes four frame members 2 and four cover strip sections 3, 4, 5, 6. Cover strip sections 3, 4 are shown in place, that is, engaged with underlying frame members. Cover strip sections 5, 6 are shown ready for assembly. Cover strip 6 is shown upside down to reveal protrusion 7, inwardly facing lateral extension 8, and outwardly facing lateral extension 9. Cover strip sections 3, 4 and cover strip sections 5, 6 illustrate two different embodiments. A first embodiment is illustrated by cover strip sections 5, 6 which are individually cut strips with mitered corners to overlie each individual framing member 2. A second embodiment is illustrated by cover strip sections 3, 4, which comprise a single strip that is “notch cut” to remove a 90 degree triangular inner piece, leaving a continuous outer edge, for example, one-eighth inch (3.2 cm) of lateral extension 9, which is then bent or folded to produce a mitered corner as shown in FIG. 1. A suitable hand tool for removing such a triangular notch is sometimes referred to as a “ninety degree sheet metal notcher.” A preferred version of this embodiment for a rectangular frame is to cut a strip of cover material to the length needed for an entire frame and notch cut four corners, making the first cut a distance from the end equal roughly to one-half the length of a side, in which case the strip ends will form a butt joint approximately at the midlength of a side. Frame members 2 include outwardly open channels 10 for receiving protrusions 7, and inwardly facing bottom extension 11. The comers where frame members 2 meet preferably are mitered. Additionally the ends of channels 10 are removed so that adjacent channels do not overlap, or abut.

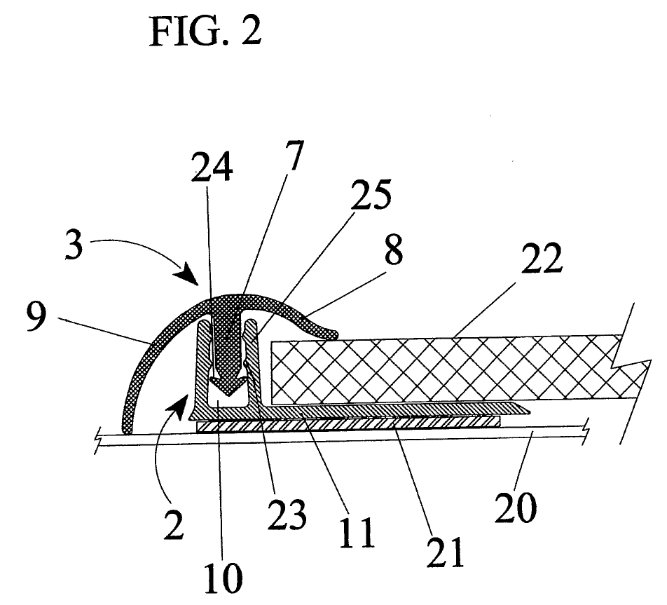

Frame 1 is suitable for mounting and tensioning a stiff sign or flexible vinyl sign (not shown). Our presently preferred procedure is as follows. First, double-stick high-bonding-strength tape 21 (FIG. 2) is applied to the underside of a length of stiff but deformable plastic extrusion, and frame members 2 are cut. Next, frame members 2 are mounted on a cargo van panel 20 (FIG. 2) by removing the parting film from the tape and pressing frame members 2 onto the panel so that tape 21 adheres to panel 20 leaving no air gaps between the frame members and the panel.

Installation of a stiff sign is better appreciated in conjunction with FIG. 2. Following installation of frame members 2 on a panel 20, stiff sign 22 is placed in the area demarcated by channels 10. Then cover sections 3, 4, 5, 6 (cover section 3 is shown in FIG. 2) are pressed into the channels. The cover sections may be individual pieces or a single notched piece, as described. In the embodiment depicted, frame member components 25 comprising the sides of channel 10 are provided with ridges 23 to help grip protrusion 7 of cover 3, and the cover is provided with deformable wings 24 for the same purpose. Inwardly facing extension 8 of cover 3 resiliently presses the edge of sign 22 against extension 11 of frame member 2 to hold sign 22 firmly in place. Outwardly facing extension 9 of cover 3 resiliently presses against panel 20. An installation option for stiff signs is to pre-assemble the frame members, the sign and a single-piece cover, and then press fit the framed sign onto a panel 20, relying on the cover to hold the pre-assembled structure together.

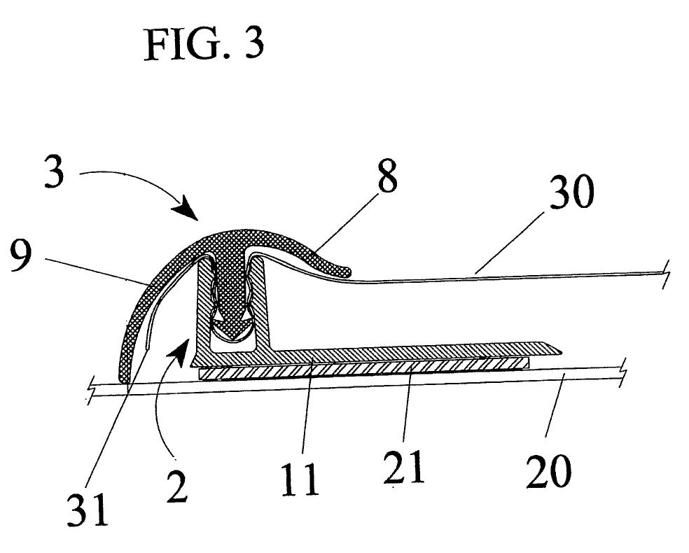

Installation of a flexible vinyl sign is better appreciated in conjunction with FIG. 3, which depicts the same frame as is shown in FIG. 2. Following installation of frame members 2 on panel 20, flexible sign 30 is placed over the frame so as to extend beyond all four channels 10. Starting with the top channel, sign 30 is pressed into the channel. For this purpose we utilize a wood stick of the appropriate size as a pusher. The edges of the stick are rounded so as not to cut sign 30. We find that vinyl signs hold their shape sufficiently for continued installation, but temporary securing means could be used to hold sign 30 in the top channel 10. Next we trim top edge 31 of sign 30 so that it will be beneath a cover section and apply cover section 3 to channel 10 leaving the cover section ends up so as to permit access to the corners of the frame. Next we tension sign 30 downwardly by hand and press the sign into the bottom channel 10, trim the bottom edge as described and apply a cover section 5 (FIG. 1), again leaving the cover section ends up. As will be appreciated, cover extensions 8 further tension the sign. Before proceeding to the vertical sides we next cut away sign material that would bunch up in the comers and tend to cause wrinkles. It is for this purpose that the channel ends were removed as shown in FIG. 1. Finally we proceed to install a first vertical edge and then the remaining vertical edge in the manner described for the bottom edge.

A number of embodiments of the invention have been described. Nevertheless, it will be understood that various modifications may be made without departing from the spirit and scope of the invention. For example, the frame members could be positioned and cut so as to form a triangular sign, or the sides of the U-shaped channels could be canted slightly, or the wings of the covers could be perpendicular to the panel instead of being angled with respect to the panel. Accordingly, other embodiments are within the scope of the following claims.

1. Framing apparatus suitable for mounting a non-rigid sign on a vertical side or rear panel of a cargo van comprising a plurality of framing members that include axially extending, open, generally U-shaped channels and that are conformable to said panel so as to form an enclosed area for said sign, said framing members having a backing of a high-bonding strength adhesive capable of quickly bonding the framing members to the panel when pressed thereagainst; and for the framing members at least one pliable cover that includes a resiliently deformable axial protrusion pressingly lockingly engageable with said channels and that further includes a first axially extension that pressingly engages said sign in said enclosed area when said protrusions are pressed into said channels.

2. The apparatus according to claim 1 wherein the framing members are backed with double-sided tape.

3. The apparatus according to claim 1 wherein the framing members additionally include axially extending wings projecting outwardly from the bottoms of said channels.

4. The apparatus according to claim 1 wherein the covers include second axial extensions that pressingly engage said panel outside said enclosed area when said protrusion are pressed into said channels.

5. The apparatus according to claim 2 wherein the framing members additionally include axially extending wings projecting outwardly from the bottoms of said channels.

6. The apparatus according to claim 2 wherein the covers include second axial extensions that pressingly engage said panel outside said enclosed area when said protrusion are pressed into said channels.

7. The apparatus according to claim 3 wherein the covers include second axial extensions that pressingly engage said panel outside said enclosed area when said protrusion are pressed into said channels.

8. The apparatus according to claim 5 wherein the covers include second axial extensions that pressingly engage said panel outside said enclosed area when said protrusion are pressed into said channels.
